(19) United States
(12) Patent Application Publication
(10) Pub. No.: US 2006/0006137 A1
(43) Pub. Date: Jan. 12, 2006

(54) Micro-fabricated sensor

(76) Inventor: Trevor Graham Edward Niblock, Sunnyvale, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/051,920

(22) Filed: Feb. 3, 2005

Related U.S. Application Data
(60) Provisional application No. 60/541,864, filed on Feb. 3, 2004.

(51) Int. Cl. B44C 1/22; G01N 27/26

(52) U.S. Cl. 216/41; 204/404; 29/592.1

(57) ABSTRACT

A Linear Polarization Resistance (LPR) sensor device for monitoring corrosion is presented. The sensor device includes a first electrode and a second electrode. The second electrode is positioned apart from the first electrode by about 1 mm or less. One or both electrodes may have a width of about 10-200 μm and a length of about 0.1-20 mm. The sensor device is electrically coupled to a controller. The controller reads the sensor measurements and transmits the readings to a remote data logger via a network interface. The device may be fabricated by etching the first side of the sensor material partway to partly form the electrodes, attaching the partly-etched side on a polymer/polyimide carrier, then patterning and etching the opposite side (which is now the top surface) in a way that is aligned with the first side. The device is cost-effective and easy to integrate into applications.

### RELATED APPLICATION

This patent application claims the benefit of U.S. Provisional Application No. 60/541,864 filed on Feb. 3, 2004 pursuant to 35 USC § 119(e) and incorporates the provisional application by reference in its entirety.

### FIELD OF INVENTION

This invention pertains generally to a sensor, and in particular to a micro-fabricated sensor.

### BACKGROUND

Every year, various companies, governments, and individuals incur high cost due to corrosion of structures. For example, the health of structures such as aircraft, ships, bridges, automobiles, pipelines, and power line towers are subject to fatigue and failure through various means, including corrosion and stress related cracking. To counteract this cost, scheduled examination and maintenance on vehicles and structures are put in place. However, the examination and maintenance does not always guarantee structural integrity. For example, a structural failure could occur between two maintenance sessions because corrosion was not bad enough to alert the examiner at the time of the first maintenance but rapid corrosion took place after the examination. Another way to counteract the loss from corrosion is Condition Based Monitoring (CBM), which entails evaluating the extent to which a structure is corroded and approximating the time at which preventative measures need to be implemented. While CBM is generally more effective than regular scheduled maintenance, it has the problem of higher cost. Once the cost of CBM becomes closer to or exceeds the cost of damages caused by corrosion itself, implementing CBM is not cost-justified.

Thus, search still continues for a sensor device that is cost effective and lends itself to easy integration with monitoring or failure prediction systems. For easy integration with existing systems, the sensor device would have to include a means for reading and logging the sensor measurements and an interface to the rest of the system without becoming too large in size.

### SUMMARY

In one aspect, the invention is a micro-fabricated sensor device useful for monitoring deterioration of a structure. The device includes a first electrode having a first finger and a second electrode having a second finger. The second finger is positioned about apart from the first finger by about 1 mm or less. The current flow between the first electrode and the second electrode correlates with a degree of deterioration of the electrodes.

In another aspect, the invention is a system for monitoring corrosion in a structure. The system includes a plurality of LPR sensors, an electronic controller, a multiplexing network, and electronic components attached to a polyimide flex circuit carrier. Each of the LPR sensors includes a working electrode and a reference electrode. The electronic controller is programmed to read measurements from each of the LPR sensors. The multiplexing network enables the controller to address each of the LPR sensors, and electronic components match the LPR sensors to the controller. The polyimide flex circuit carrier has passivated metal interconnects and bond pads onto which the LPR sensors, the electronic components, the electronic controller, and the multiplexing network are attached.

In yet another aspect, the invention is a method of preparing a sensor device. The method includes providing an electrically conductive material having a first surface and a second surface that are in substantially parallel planes with respect to each other. The first surface is photolithographically patterned with a first electrode having first fingers and a second electrode having second fingers, and the patterned electrodes are etched partway between the first surface and the second surface. The partly-etched electrically conductive material is mounted on a carrier with the first surface contacting the carrier and heated to be bonded. The second surface is photolithographically patterned with the first and the second electrodes that are aligned with the etched portions of the first surface, and the patterns are etched until the first and the second electrodes are formed.

### BRIEF DESCRIPTION OF THE DRAWINGS

FIG. 1 is a schematic diagram of a micro-fabricated linear polarization resistance (LPR) sensor in accordance with the invention.

FIG. 2 is a schematic illustration of a flex circuit carrier that may be coupled with the sensor of FIG. 1.

FIGS. 3A and 3B are flow diagrams depicting a method of combining the sensor with the flex circuit carrier to produce the sensor device.

FIGS. 4A and 4B are schematic illustrations of a sensor device that includes the sensor and a flex circuit carrier.

FIGS. 5 and 6 are DC and AC instrumentation amplifier circuits that may be used in the sensor device.

FIG. 7 shows an exemplary set of measurements for a single sensor sweep.

FIG. 8 illustrates the effective resistance of the sensor as a function of time exposed to a humidified atmosphere.

FIG. 9 is a diagram of a circuit for controlling the potential applied to the first and the sensor.

### DETAILED DESCRIPTION OF THE PREFERRED EMBODIMENT

Embodiments of the invention are described herein in the context of a dual-electrode corrosion sensor. However, it is to be understood that the embodiments provided herein are just preferred embodiments, and the scope of the invention is not limited to the applications or the embodiments disclosed herein. For example, the invention may be adapted for other types of corrosion sensors, or sensors that measure stress, humidity, pH, temperature, and chemical ion detection.

In one aspect, the present invention describes a miniature or micro corrosion sensor and its method of fabrication. Other aspects of the invention describe a system platform in which at least one or more corrosion sensors are integrated on a common substrate.

As a material corrodes and forms an oxide, the oxide creates an anodic cell. If the corroding material has two sections, a. potential and resistance can be measured between the two sections. The potential and resistance values can be used to compute the effective mass loss of the device. The device is most useful if the sensor material is matched to the properties of the structure that is being monitored, so that it is possible to establish a corrosion rate of the structure. To form a sensor device that can be manufactured cost effectively and can be easily integrated into monitoring systems, the two-section sensor is integrated with microfabricated peripheral electronics.

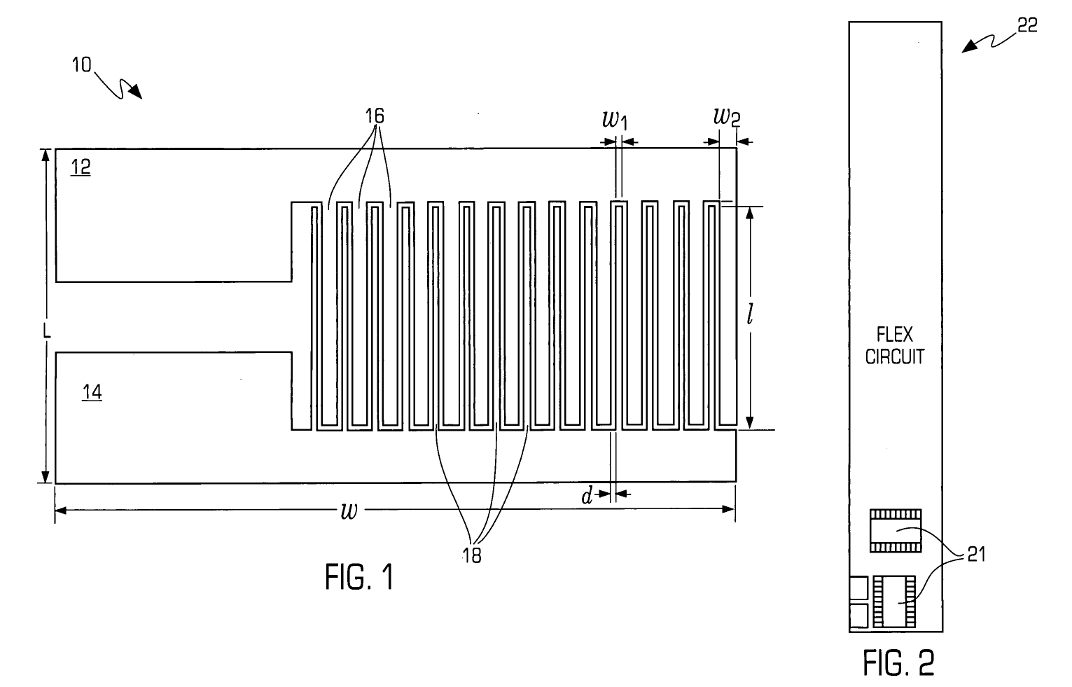

FIG. 1 is a schematic diagram of a micro-fabricated linear polarization resistance (LPR) sensor 10 in accordance with the invention. As shown, the LPR sensor has a first electrode 12 and a second electrode 14 that are patterned in an interlaced manner. The first electrode 12 has first fingers 16 and the second electrode 14 has second fingers 18 that are interlaced with the first fingers 16. The first fingers 16 and the second fingers 18 do not touch each other, but are spaced apart by a gap d. The distance d between the first fingers 16 and the second fingers 18 determines the sensitivity of the sensor 10. The thickness of the sensor 10 (which is measured into the page on FIG. 1) determines how long the sensor 10 will be operational. The thicker the material, the more mass there is to corrode and the longer it will take for the sensor 10 to reach its operational limit.

To form an exemplary embodiment of the sensor 10, shim stock of the particular material having a thickness less than 75 μm (e.g., 50 μm) is photolithographically patterned to form the interlaced electrode array. The widths (w₁, w₂) of the first and second fingers 16, 18 may be in the range of 10-200 μm, with lengths (l) of 0.1-20 mm, although the invention is not limited to these dimensions. The gap (d) between the first fingers 16 and the second fingers 18 may be any size up to 1 mm, and can be selected according to the desired sensitivity level. In the exemplary embodiment, the gap d is set at 150 μm, the first fingers 16 have a width w₁ of 450 μm, and the second fingers 18 have a width w₂ of 150 μm. The overall sensor length L is 9.5 mm and the overall sensor width W is 20 mm in this exemplary embodiment. The sensor 10 is preferably made of the same material as the as the structure that is being monitored or a shim stock matched to the material of the structure (e.g., Aluminum 1020, stainless steel). More specifically, the sensor 10 may be made from the same material as the structure that is being monitored.

As already mentioned, the LPR sensor 10 is made of a material that corrodes, such as the material of the structure being monitored. Corrosion occurs when a metal or alloy (herein collectively referred to as “metal”) is exposed to a fluid of sufficient oxidizing power. At the interface between the metal and the fluid, metal ions escape from the metal surface, leaving a surplus of electrons. The excess electrons flow from the anodic sites on the metal surface to cathodic sites where they are consumed, creating a corrosion current. A corrosion current, thus, is a measure of the loss of the metal from the metal surface. The corrosion current (I_{corr}) can be calculated from the linear polarization resistance and used to estimate the corrosion rate. However, as the anodic and cathodic sites continually shift and change their positions, I_{corr} cannot be directly measured from the metal surface. Hence, a small potential drop (ΔE) is applied externally to induce a measurable current flow (ΔI) at the corroding surface. At a given value of ΔE, I_{corr} is directly proportional to the induced current ΔI, as shown by Equation 1:

$$\frac{Δ E}{Δ I} = \frac{{β}_{a} \times {β}_{b}}{2.303 \times {I}_{corr} \times ( {β}_{a} + {β}_{b} )} \qquad ( Equation 1 )$$

In Equation 1, βₐ and β_{b} are Tafel constants that can be obtained from a well-known Tafel plots for the system under consideration.

A potentiostat may be used to adjust the potential (ΔE) on the metal surface in a controlled manner so that the corresponding current values can be measured as a function of the potential. The relationship between ΔE and ΔI is linear at values of ΔE close to that of the equilibrium potential, which is assumed by the metal in the absence of any induced potential ΔE. The slope of this line has the value ΔE/ΔI and has the units of resistance. The slope is therefore called “polarization resistance.” The value of polarization resistance obtained from a potential sweep over a predetermined range can then be used to determine I_{corr} by using the relationship of Equation 1. Furthermore, the rate of corrosion (CR) may be calculated by using I_{corr} and the relationship of Equation 2:

$$C R = \frac{{I}_{corr} \times k \times E W}{d \times A} \qquad ( Equation 2 )$$

where EW=equivalent weight of the material in grams/equivalent,
k=a constant,
d=density of the corroding material, and
A=area of the sample.

While the sensor 10 described in this invention is a micro-LPR sensor, other sensors that lend themselves to miniaturization (e.g., sensors for strain, pH, humidity, and temperature) may also be used in the sensor device described herein.

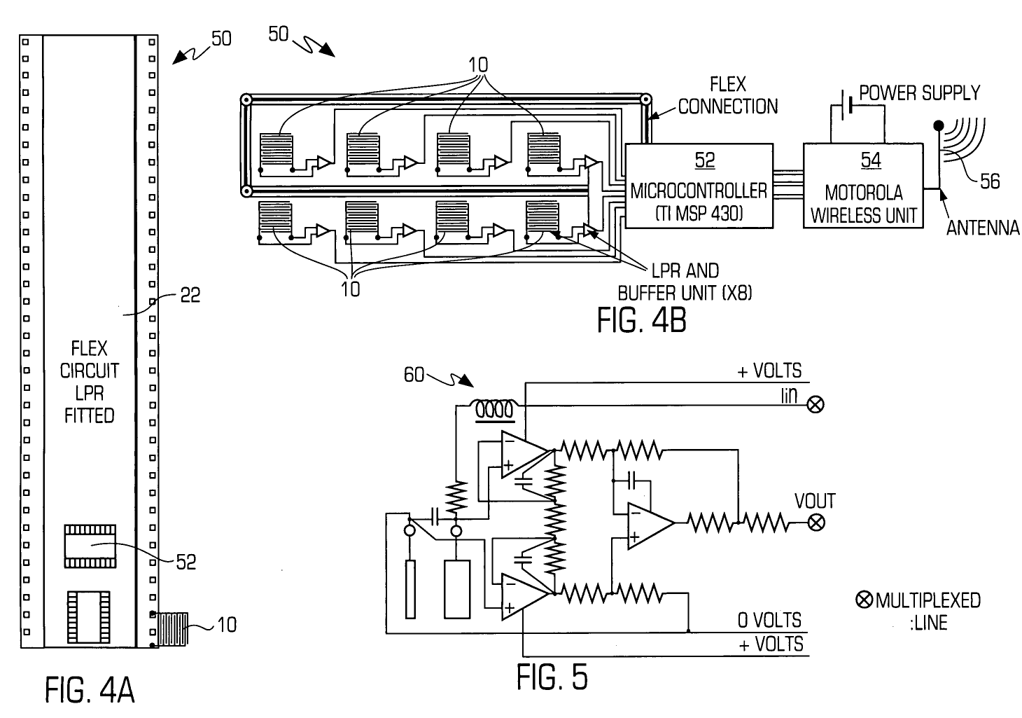

FIG. 2 is a schematic illustration of a flex circuit carrier 22 that may be coupled with the sensor 10. The flex circuit 22 is a commercially available component such as a polymer/polyimide flexicircuit carrier (e.g., Flexi907 made by 3M) and provides a platform on which one or more of the sensors 10 is mounted. The flex circuit carrier 22 includes bond pads 21 for electronics that support the sensor 10, such as electronics for interrogating the sensor 10 to acquire data, electronics for power management, electronics for wireless transmission, and a controller. These electronics are shown in FIG. 4B below. Furthermore, there are electrical leads in the flex circuit 22 that are embedded in the flexible polymer/polyimide substrate (e.g., a buffer circuit for each sensor 10). The electrical leads may be about 50-200 μm thick, and can be formed as a sheet or even as a roll of tape. The electrical leads are copper traces, for example, which are patterned to form routing interconnects between the system controller and the sensor array. The copper is electrodeposited to thicknesses of approximately 20 μm in order to provide very low resistance, thereby minimizing signal losses. As shown, the flex circuit carrier 22 has at least one bond pad 21 for mounting the sensor 10 or the supporting electronic components. The bond pad 21 of the flexi circuit carrier 22 provides a platform that is corrosion resistant and electrically nonconductive onto which one or more sensors 10 or electronic components can be mounted. The patterned leads are coated with another layer of polyimide or a silicone agent to electrically passivate the connection. However, the bond pads 21 remain uncoated.

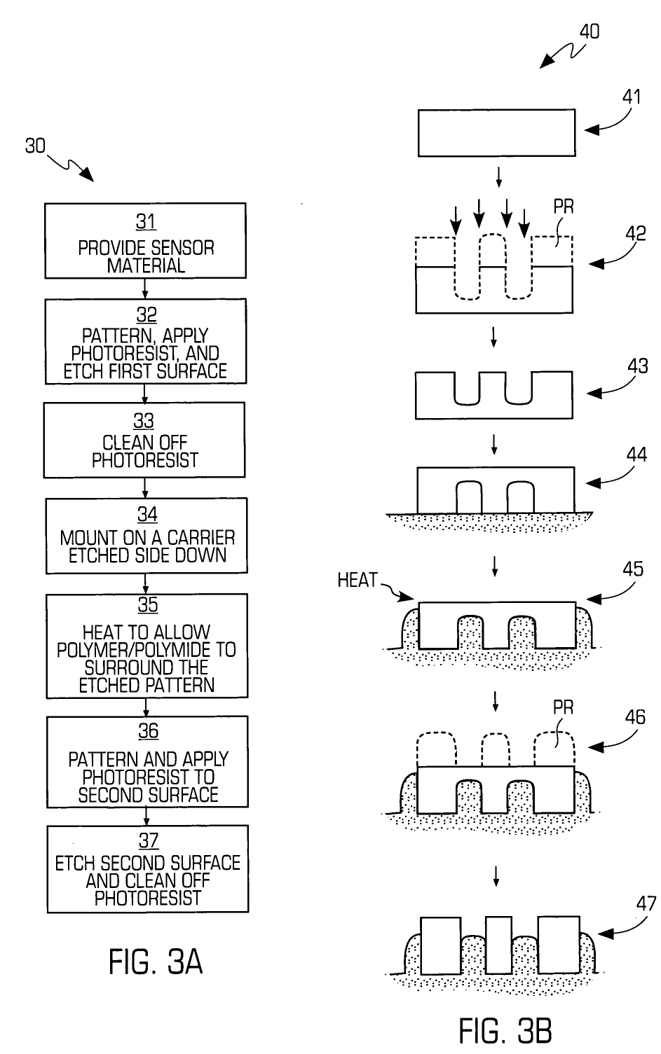

FIGS. 3A and 3B are flow diagrams 30, 40 depicting a method of combining the sensor 10 with the flex circuit carrier 22 to produce a sensor device. The sensor 10 may be made by first providing the sensor material (steps 31 and 41) and etching the desired pattern by using techniques such as chemical, electrochemical, laser, or other etching/machining techniques known in the art (steps 32 and 42). For example, the electrode pattern may be chemically etched from one side to approximately half way through the thickness of the shim stock material. The etching is done using ferric chloride, for example. Depending on the particular material making up the sensor, e.g., aluminum, nickel, stainless steel, copper, etc., other chemical etchants (e.g., various acids such as phosphoric, hydroflouric, nitric or hydrochloric acid) may be used instead of ferric chloride. The etched side is then cleaned of the photoresist (steps 33 and 43) and mounted face down onto a polymer or a polyimide carrier (steps 34 and 44). Bonding is achieved by heating the material such that the polyimide flows to surround the surfaces of the electrode pattern already etched (steps 35 and 45). An elevated pressure may be applied during the heating. Electrodes on the top (unetched) side of the shim stock material are then aligned and patterned photolithographically (steps 36 and 46). The electrodes are formed by completing the chemical etch the remainder of the way through the sensor material (steps 37 and 47).

This method depicted in the flow diagrams 30, 40 enables handling and further packaging of the sensor 10 by mounting it on a carrier. The polymer/polyimide coating that surrounds the fingers 16, 18 of the sensor 10 protects the sidewalls of the etched electrodes, such that the corrosion resistance remains linear over a greater range of material corrosion and is thus more accurate in predicting the amount of corrosion. Specific components of the system can be protected from the surrounding environment by encapsulation techniques, such as coating with a layer of silicon adhesive to hermetically seal and protect the electronics from the surrounding environment, while the sensor 10 is appropriately exposed to the same environment which the structure being monitored experiences. In fabricating the sensor device, care must be taken to expose only the top surface to the atmosphere, with a substantial portion of the side surfaces being encapsulated in the corrosion resistant material.

Alternatively, for certain materials, electroplating or vacuum depositing of predefined patterns will also form the sensor device.

FIG. 4A and 4B are schematic illustrations of a sensor device 50, which includes the sensor 10 and the flex circuit carrier 22. The sensor 10 is directly attached to the flex circuit carrier 22 with the electrodes aligned and attached to the exposed bondpads 21 (see FIG. 2). FIG. 4B illustrates how a plurality of sensors 10 can be multiplexed and connected to a microcontroller 52 (e.g., TI MSP 430). The microcontroller 52 interrogates the sensors 10 and collects readings. A wireless unit 54, which is also coupled to the microcontroller 52, handles power and transmits the collected readings to an appropriate data logger, for example via an antenna 56. Although FIG. 4B depicts one possible embodiment of the sensor device 50, different embodiments may be used as appropriate for particular applications. For example, in some embodiments, the connection between the sensor device 50 and the data logger may not be wireless. In other embodiments, there may be a memory coupled to the microcontroller 52 that locally logs the collected readings.

The flex circuit carrier 22 may be provided with an appropriate adhesive which allows the entire system to be directly attached to the structure being monitored.

FIG. 5 is a DC instrumentation amplifier circuit 60 that may be used in the sensor device 50. The DC circuit 60 may be implemented with LPC660 op-amps, which provide high impedance and low input currents. In operation, a known current is supplied to the electrodes 12, 14 and the voltage developed across the electrodes 12, 14 is measured. The reverse current is then supplied and the voltage measured. These two voltage-current measurements give the resistance. Care is taken to ensure that ΔV from the rest potential does not exceed +/−20 mV. Various inductors and capacitors are used to reduce RF noise. The amount of noise that is picked up by the circuit 60 is further reduced by placing the LPR sensor 10 in direct contact with the flex circuit carrier 22 and encapsulating the circuit 60 in a polymer to ensure that it was not exposed to the corrosive environment.

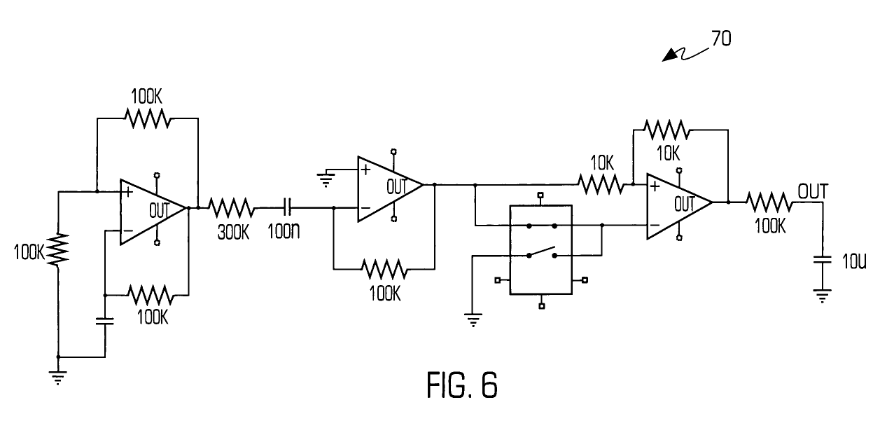

FIG. 6 is an AC amplifier circuit 70 that may be used in the sensor device 20. It may be preferable to use an AC current to excite the sensor 10 than to use a DC current because any reaction caused in one half cycle would be reversed in the other, having no net effect, and thus allowing bigger signals to be used. Also, the AC circuit 70 is immune to DC potentials in the sensor 10. The first op-amp is used to make the oscillator, which feeds the sensor in series with a capacitor to block any DC current. The second op-amp produces an output proportional to the conductance of the sensor. The third op-amp turns the AC signal to DC to feed into the data acquisition system, be it microcontroller or computer. The RC on the output reduces ripple, however, it requires a few seconds charge-up time.

### EXAMPLE 1

### Micro-LPR Device Fabrication and Test

A device is made using the same material (“the source material”) as the structure to be monitored. The device can be made from the actual source material, or from shim stock matched to the source material. For the initial device fabrication, original source material (1.6 mm thick) was milled into 25 mm squares, then ground down to 200 μm using the double disk grinding technique. The squares were lapped to further reduce the material down to 50 μm and 100 μm thickness. In conjunction with this process, standard shim stock (50 μm and 100 μm thick) of the same material type was used. Using this sensor, the effect on sensor sensitivity due to material property fluctuation could be monitored. The sensor was mounted on a non-conducting platform that includes DuPont's Kapton®, which is not susceptible to corrosion and is not electrically conductive. The device was then fabricated so that only its top surface would be exposed to the atmosphere while the rest is encapsulated in the polymer. This selective exposure of the top surface is achieved by attaching the sensor material directly to the polyimide carrier. A photolithographic pattern is then formed in a photoresist coating applied to the top surface of the sensor material, providing the layout of the electrodes. Chemical etching is performed to remove the material exposed by the pattern, leaving behind the electrode fingers and interconnects.

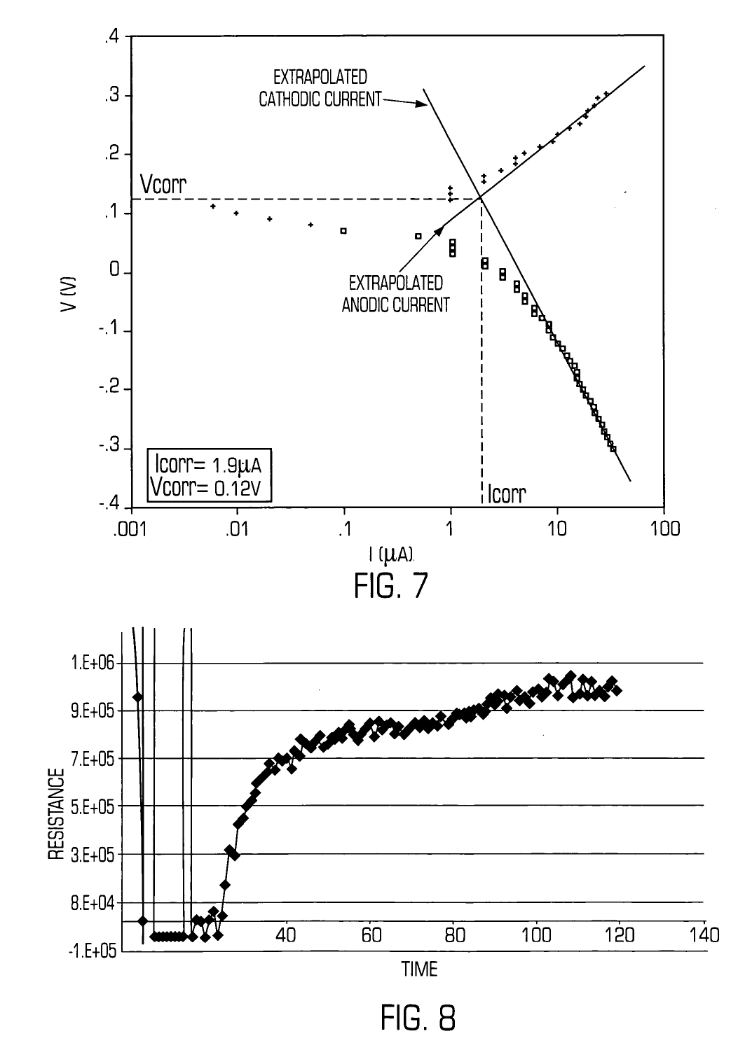

Matching electronics are integrated with the fingers of the sensor electrodes. The matching circuit consists of appropriate capacitance, resistance, and operational amplifiers such that the signal being sent by the digital data acquisition device is converted to analog and back in a well-known fashion, so as to be accurately stored for later evaluation. The sensor testing is done utilizing an electronic controller chip which is programmed to periodically interrogate specific sensors and store the data. The controller first conducts a baseline calibration to determine the zero-current voltage, then sweeps the voltage from −100 mV to +100 mV from the baseline voltage. At each voltage increment, which may be 1-10 mV, the current through the sensor is measured and stored. FIG. 7 shows an exemplary set of measurements for a single sensor sweep. The results are subsequently compared to the previously measured data for that sensor or a complete histogram in order to evaluate changes occurring over time.

FIG. 8 illustrates the effective resistance of the sensor as a function of time exposed to a humidified atmosphere. The increase in resistance as a function of time indicates the effects of corrosion due to mass loss of the sensor electrodes. These results can also provide mass loss rates due to corrosion, which further assist in prediction of structural failure. The controller can be interfaced to a wireless or hard-wire communication link, so as to transmit the data after each measurement, or other scheduled periods which make sense.

In practice, a plurality of sensors 10 can be incorporated onto a sheet of flexible circuit material as described previously, and multiplexed via the copper interconnects. The array of sensors can be controlled by a single data acquisition device, and can reasonably be distributed over areas on the order of a few meters square. In order to monitor large structures, it is expected that numerous sensor systems would be applied to provide accurate monitoring over a large percentage of the area of the structure.

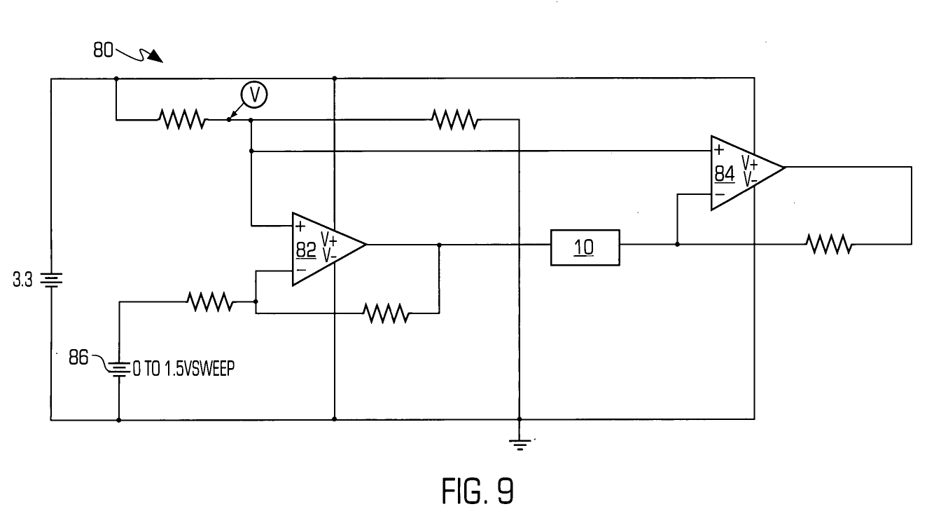

FIG. 9 is a diagram of a circuit 80 for controlling the potential drop (ΔE) applied to the first and the second electrodes 12, 14 of the sensor 10 (see FIG. 1). The voltage divider formed by R1 and R15 sets the inverted input voltage for a first op-amp 82 and a second op-amp 84. By varying the voltage on the input of a DAC 86 between 0 and 1.5 V with R16, the potential on the sensor 10 is stepped down. The resistances are chosen so that the value of R16 is greater than that of R17 according to the drop in the potential. By using field effect transistor (FET) op-amps, the current that passes into the v+ and v− terminals are kept at a low level or eliminated. A dramatic increase in the output amplification can be achieved by increasing the resistance value of R20.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

What is claimed is:

1. A micro-fabricated sensor device useful for monitoring deterioration of a structure, the device comprising:
a first electrode having a first finger; and
a second electrode having a second finger, wherein the second finger is separated from the first finger by about 1 mm or less;
wherein a current flow between the first electrode and the second electrode indicates a degree of deterioration of the first and second electrodes.

2. The device of claim 1, wherein at least one of the first and the second electrodes has a thickness less than about 75 μm.

3. The device of claim 1 further comprising a carrier, wherein the first electrode and the second electrode are mounted on the carrier.

4. The device of claim 3, wherein the carrier comprises a polymer layer.

5. The device of claim 3, wherein the carrier comprises a polyimide layer.

6. The device of claim 3 further comprising electronic components formed on the carrier, wherein the electronic components make an electrical connection with the first and second electrodes when the first and the second electrodes are mounted on the carrier.

7. The device of claim 6, wherein the electronic components comprise a controller for reading data from the first and the second electrodes.

8. The device of claim 7, wherein the electronic components comprise a transmitter for transmitting the read data to a remote unit.

9. The device of claim 7, wherein the controller interfaces a wireless communication link.

10. The device of claim 7, wherein the controller reads current flowing between the first electrode and the second electrode at different voltages within a predetermined voltage range.

11. The device of claim 10, wherein the predetermined voltage range is between about −100 mV and about 100 mV.

12. The device of claim 6, wherein the electronic components are hermetically sealed in a silicone potting agent.

13. The device of claim 3, wherein the carrier has an adhesive backing for attaching to the structure being monitored.

14. The device of claim 1, wherein the first finger is a set of first fingers and the second finger is a set of second fingers, wherein the first fingers and the second fingers are arranged in an interdigitated manner.

15. The device of claim 1, wherein the device is made of the same material as the structure being monitored.

16. The device of claim 1, wherein the first and the second electrodes comprise stainless steel or aluminum.

17. The device of claim 1, wherein at least some of the first and second fingers have a width of about 10-200 μm and a length of about 0.1-20 mm.

18. A system for monitoring corrosion in a structure, the system comprising:
a plurality of LPR sensors, wherein each of the LPR sensors includes a working electrode and a reference electrode;
an electronic controller programmed to read measurements from each of the LPR sensors;
a multiplexing network that enables the controller to address each of the LPR sensors;
electronic components that match the LPR sensors to the controller;
a flex circuit carrier having passivated metal interconnects and bond pads onto which the LPR sensors, the electronic components, the electronic controller, and the multiplexing network are attached.

19. The system of claim 18, wherein the LPR sensors include an interdigitated electrode finger array.

20. The system of claim 19, wherein the interdigitated electrode fingers in the electrode finger array are spaced apart from each other by about 1 mm or less.

21. A method of preparing a sensor device, the method comprising:
providing an electrically conductive material having a first surface and a second surface that are in substantially parallel planes with respect to each other;
photolithographically patterning a first electrode having first fingers and a second electrode having second fingers onto the first surface;
etching the patterned electrodes to partway between the first surface and the second surface;
mounting the electrically conductive material on a carrier with the first surface contacting the carrier;
bonding the electrically conductive material to the carrier by applying heat;
photolithographically patterning the first and the second electrodes on the second surface such that the pattern is aligned with the etched portions of the first surface; and
etching the pattern into the second surface until the first and the second electrodes are formed.

22. The method of claim 20 further comprising etching the patterned electrodes to form the first and the second fingers that are about 10-200 μm wide and 0.1-20 mm long.

23. The method of claim 20 further comprising etching the first and second fingers so that the first fingers are spaced apart from the second fingers by about 1 mm or less.

24. The method of claim 21, wherein the etching comprises chemical etching.

25. The method of claim 21, wherein the etching comprises laser machining.

26. The method of claim 21, wherein the etching comprises machining.

27. The method of claim 21, wherein the etching comprises electrostatic discharge machining.

28. The method of claim 21, wherein mounting the electrically conductive material on the carrier comprises mounting the electrically conductive material on a polymer layer.

29. The method of claim 21, wherein mounting the electrically conductive material on the carrier comprises mounting the electrically conductive material on a polymer layer.

30. The method of claim 21 further comprising connecting the first and second electrodes with electrical components on the carrier.

31. The method of claim 30 further comprising passivating the electrical components by depositing silicone agent over the electrical components.

32. A micro-fabricated sensor device useful for monitoring deterioration of a structure, the device comprising:
a first electrode; and
a second electrode positioned at most about 1 mm apart from the first electrode;
wherein a current flow between the first electrode and the second electrode indicates a degree of deterioration of the first and second electrodes.

33. The device of claim 32, wherein some parts of the first and second electrodes have a width of about 10-200 μm and a length of about 0.1-20 mm.
